(19) United States
(12) Patent Application Publication
(10) Pub. No.: US 2023/0314784 A1
(43) Pub. Date: Oct. 5, 2023

(54) OCULAR TUBE

(71) Applicant: Evident Corporation, Nagano (JP)

(72) Inventors: Kosuke MIMBUTA, Nagano (JP); Izumi SHOMURA, Nagano (JP); Sho MAKITA, Nagano (JP); Yosuke TANI, Nagano (JP)

(73) Assignee: Evident Corporation, Nagano (JP)

(21) Appl. No.: 18/115,021

(22) Filed: Feb. 28, 2023

(30) Foreign Application Priority Data
Mar. 8, 2022 (JP) 2022-035426

(51) Int. Cl. G02B 21/22; H04N 23/56; H04N 23/55

(52) U.S. Cl. CPC G02B 21/22; H04N 23/55; H04N 23/56; G02B 2207/117

(57) ABSTRACT

An ocular tube for a microscope, to which an ocular lens is to be attached, includes a superimposition device that superimposes an assistive image on an image plane on which an optical image is formed with light from the microscope.

### CROSS REFERENCE TO RELATED APPLICATIONS

This application is based upon and claims the benefit of priority from prior Japanese Patent Application No. 2022-035426, filed Mar. 8, 2022, the entire contents of which are incorporated herein by this reference.

### TECHNICAL FIELD

The disclosure of the present specification relates to an ocular tube.

### BACKGROUND

Although the automation of work with robots or the like has advanced, there are not a few products requiring handwork for assembly. Examples of such products include medical devices. Assembly of a precision device like a medical device is often carried out under a microscope because many pieces of minute work are required. Thus, a stereoscopic microscope is often used that enables stereoscopic vision of a target with both eyes.

However, in order to check a procedure manual while carrying out assembly work with observation of a target, a worker needs to move the eyes away from ocular lenses and to turn the eyes on, for example, a display on which the procedure manual is displayed. Then, after checking, the worker resumes the assembly work through the ocular lenses, leading to inefficient work.

An exemplary technology related to solution of such a problem is described in WO 2018/042413 A. A microscope system described in WO 2018/042413 A projects an image onto the intermediate image position of a microscope (hereinafter, the image is referred to as an AR image), enabling acquisition of necessary information with viewing through eyepiece.

### SUMMARY

According to one aspect of the present invention, provided is an ocular tube for a microscope, to which an ocular lens is to be attached, including a superimposition device that superimposes an assistive image on an image plane on which an optical image is formed with light from the microscope.

### BRIEF DESCRIPTION OF DRAWINGS

The present invention will be more apparent from the following detailed description when the accompanying drawings are referenced.

FIG. 1 illustrates the configuration of a microscope system according to an embodiment of the present invention;

FIG. 2 illustrates the configuration of a microscope according to the embodiment of the present invention;

FIG. 3 is an explanatory view for the configuration of an image formed on an image plane;

FIG. 4 is a perspective view of the microscope according to the embodiment of the present invention viewed from obliquely in front;

FIG. 5 is a perspective view of the microscope according to the embodiment of the present invention viewed from obliquely behind;

FIG. 6 is a perspective view of an ocular tube according to the embodiment of the present invention;

FIG. 7 is a front view of the ocular tube according to the embodiment of the present invention;

FIG. 8 is a top view of the ocular tube according to the embodiment of the present invention;

FIG. 9 illustrates the configuration of the ocular tube according to the embodiment of the present invention;

FIG. 10 illustrates an optical path in the ocular tube according to the embodiment of the present invention viewed from obliquely in front;

FIG. 11 illustrates an optical system in the ocular tube according to the embodiment of the present invention viewed from obliquely in front;

FIG. 12 illustrates the optical path in the ocular tube according to the embodiment of the present invention viewed from obliquely behind;

FIG. 13 illustrates the optical system in the ocular tube according to the embodiment of the present invention viewed from obliquely behind;

FIG. 14 illustrates a configuration for guiding light branching off from the observation optical path of a stereoscopic microscope to an image capturing device;

FIG. 15 illustrates a configuration for guiding light emitted from a projector to the observation optical path of the stereoscopic microscope, viewed from obliquely above; and

FIG. 16 illustrates the configuration for guiding light emitted from the projector to the observation optical path of the stereoscopic microscope, viewed from above.

### DESCRIPTION OF EMBODIMENTS

A microscope system described in WO 2018/042413 A has a configuration in which an intermediate tube including a projector is attached, for projection of an AR image, between an ocular tube and the body of a microscope. However, addition of the intermediate tube to the microscope causes the eye points previously designed at a favorable height to rise by the height of the intermediate tube. A variation in the height of location of the eye points is likely to cause deterioration in the ergonomic performance of the system, leading to adverse influence on the posture of the user at the time of observation.

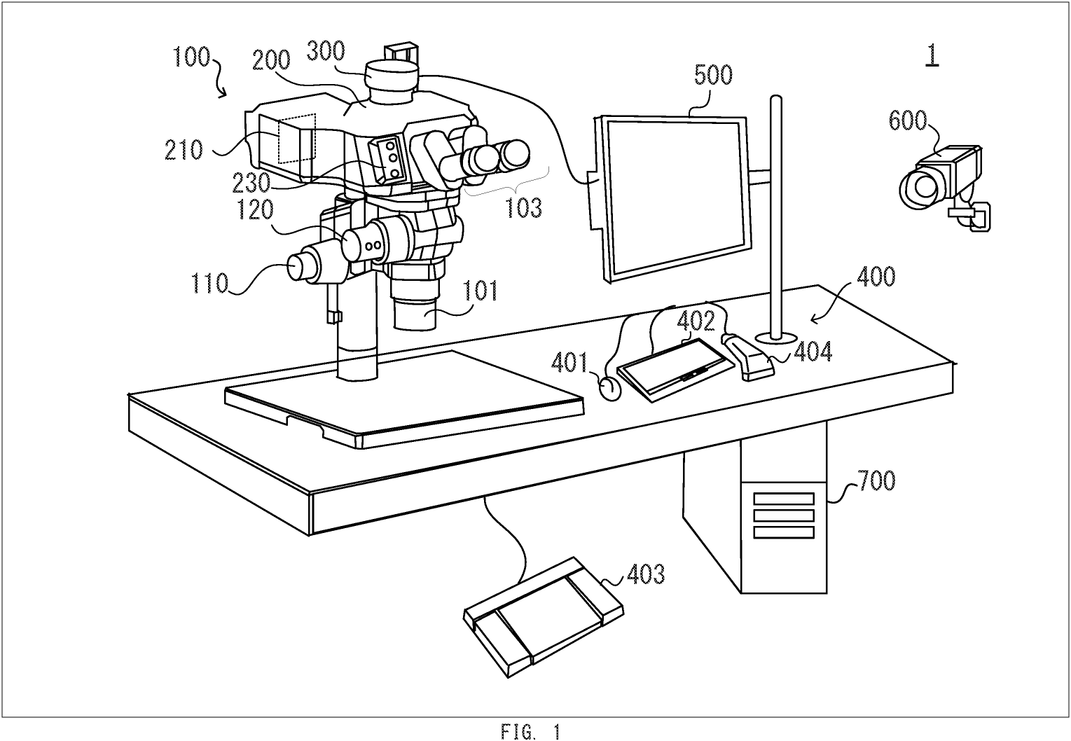

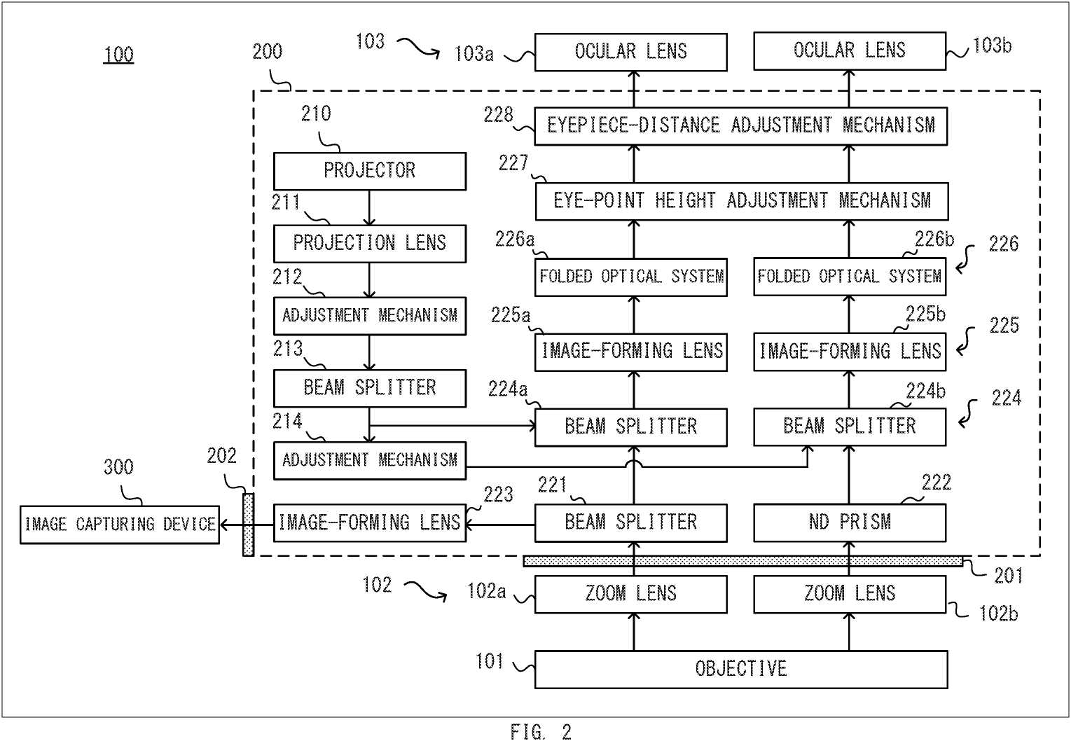

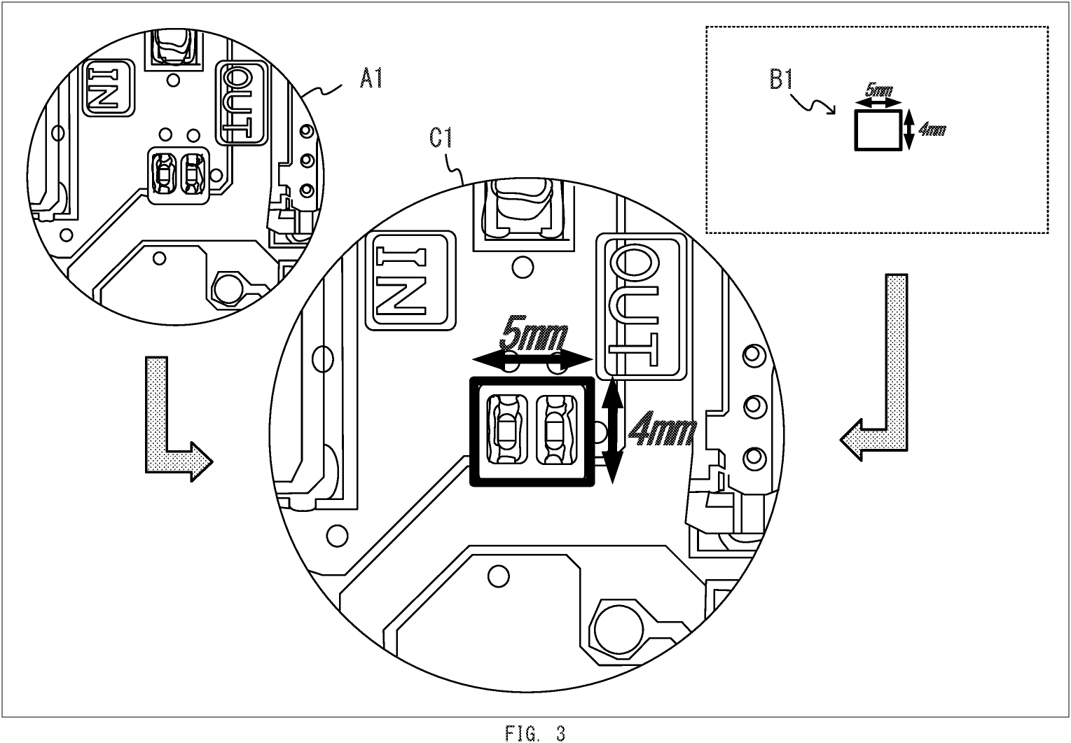

FIG. 1 illustrates the configuration of a microscope system according to an embodiment of the present invention. FIG. 2 illustrates the configuration of a microscope according to the embodiment of the present invention. FIG. 3 is an explanatory view for the configuration of an image formed on an image plane. The microscope system 1 illustrated in FIG. 1 provides necessary information to the user who is carrying out microscopic work through ocular lenses 103. The configuration of the microscope system 1 will be described with reference to FIGS. 1 to 3.

As illustrated in FIG. 1, the microscope system 1 includes a microscope 100, a plurality of input devices 400, a monitor 500, a Web camera 600, and a control device 700.

The microscope 100 serves as a stereoscopic microscope enabling both visual observation with the ocular lenses 103 and digital shooting with an image capturing device 300. As illustrated in FIG. 2, the microscope 100 has, for visual observation, a right-eye optical path and a left-eye optical path, independently. Observation of an optical image of a sample formed on the right-eye optical path by the right eye through one of the ocular lenses 103 (ocular lenses 103a and 103b) and observation of an optical image of the sample formed on the left-eye optical path by the left eye through the other enable stereoscopic observation of the sample. Thus, the microscope 100 is suitable for use, for example, in the work of assembly of a precision device.

The microscope 100 includes a focusing handle 110. Operating the focusing handle 110 changes the distance between the sample and an objective 101. Thus, the microscope 100 can be focused on the sample.

The microscope 100 includes zoom lenses 102 (zoom lenses 102a and 102b) operable through a zoom handle 120. Operating the zoom handle 120 enables a change in observation magnification with the sample under observation through the ocular lenses 103.

The microscope 100 includes an ocular tube 200 detachable. The ocular tube 200 corresponds to an ocular tube for a microscope to be attached to a stereoscopic microscope and has the right-eye optical path and the left-eye optical path, described above, inside. The ocular tube 200 serves as a trinocular tube to which the ocular lenses 103 (ocular lenses 103a and 103b) and the image capturing device 300 are attached.

The ocular tube 200 includes a circular joint 201 as an attachable structure to the microscope 100. The circular joint 201 serves as a fastener that fastens the ocular tube 200 detachably to the microscope 100. The circular joint 201 has an input opening through which light travels from the microscope 100.

The ocular tube 200 includes a circular joint 202 as an attachable structure to the image capturing device 300. The circular joint 202 serves as a fastener that fastens the ocular tube 200 detachably to the image capturing device 300. The circular joint 202 has an output opening through which light travels from the ocular tube 200 to the image capturing device 300.

The ocular tube 200 includes a projector 210. With the ocular tube 200 attached to the microscope 100, the projector 210 projects information necessary for the user, as an assistive image, on the image plane on which an optical image of the sample is formed with light from the microscope 100. For example, the projector 210 may be achieved with a liquid crystal device, a DMD (registered trademark) device, or an organic EL device, and may be of a single type or a triple type.

The projector 210 serves as a superimposition device that projects an assistive image on the image plane such that the assistive image is superimposed on the optical image. More specifically, the projector 210 projects, on the image plane, the assistive image designated by a command from the control device 700. Thus, for example, as illustrated in FIG. 3, through the ocular lenses 103, the user can observe a superimposition image, in which an assistive image B1 is superimposed on an optical image A1, formed on the image plane.

The user operates an operation unit 230 to switch the projection function of the projector 210 between ON and OFF, so that an instruction for starting superimposition of the assistive image onto the image plane or an instruction for stopping the superimposition can be given.

Note that the assistive image corresponds to augmented reality displayed in superimposition on the optical image of the actual sample. Thus, hereinafter, the assistive image is also referred to as an AR image, and projecting the assistive image on the image plane, namely, allowing the user to visually identify the assistive image is also referred to as AR display.

Light from the projector 210 is guided to the right-eye optical path and the left-eye optical path through a projection lens 211, a beam splitter 213, and adjustment mechanisms (adjustment mechanisms 212 and 214). The adjustment mechanisms 212 and 214 each adjust the position of the assistive image on the image plane.

Hereinafter, the right-eye optical path and the left-eye optical path are also collectively referred to as an observation optical path. The optical path from the projector 210 to the observation optical path is referred to as an AR optical path. In addition, as described below, the optical path branching off from the observation optical path to the image capturing device 300 is referred to as an image capturing optical path.

The right-eye optical path and the left-eye optical path provided in the ocular tube 200 are basically similar in configuration. Specifically, the ocular tube 200 includes beam splitters 224 (beam splitters 224a and 224b), image-forming lenses 225 (image-forming lenses 225a and 225b), and folded optical systems 226 (folded optical systems 226a and 226b), respectively, on the right-eye optical path and the left-eye optical path. Note that the beam splitters 224 are each an exemplary first optical element. The light having passed through the optical systems is then guided to the ocular lenses 103 through an eye-point height adjustment mechanism 227 and an eyepiece-distance adjustment mechanism 228.

Note that the right-eye optical path and the left-eye optical path are different in that only one of the right-eye optical path and the left-eye optical path is provided with a beam splitter 221 that guides light to the image capturing optical path. Note that the beam splitter 221 is an exemplary second optical element. The other of the right-eye optical path and the left-eye optical path, which is provided with no beam splitter 221, is provided with a ND prism 222 instead of a beam splitter 221.

On the one of the right-eye optical path and the left-eye optical path, which is provided with the beam splitter 221, part of light having entered the beam splitter 221 is guided to the image capturing optical path. Thus, the quantity of light reduced by the part reaches the corresponding ocular lens 103. The ND prism 222 reduces incident light by a quantity of light equal to the quantity of light guided to the image capturing optical path by the beam splitter 221. Thus, the ND prism 222 has a function of reducing the difference between the quantity of light from the right-eye optical path to the corresponding ocular lens 103 and the quantity of light from the left-eye optical path to the corresponding ocular lens 103.

The microscope 100 includes the image capturing device 300 that captures the sample to acquire a digital image of the sample. The image capturing device 300 is attached to the ocular tube 200 through the circular joint 202. The image capturing optical path in the ocular tube 200 is provided with an image-forming lens 223 different from the image-forming lenses 225 on the observation optical path. The image-forming lens 223 is an exemplary second image-forming lens and condenses, on the image capturing face of the image capturing device 300, the light guided from the observation optical path to the image capturing optical path by the beam splitter 221.

The image capturing device 300 serves as a digital camera including a two-dimensional image sensor. Examples of such an image sensor include, but are not particularly limited to, a CCD image sensor and a CMOS image sensor. The digital image acquired by the image capturing device 300 is output to the control device 700. The digital image may be output directly to the monitor 500.

The input devices 400 and the monitor 500 are in connection with the control device 700. Examples of the input devices 400 may include, but are not particularly limited to, as illustrated in FIG. 1, a mouse 401, a keyboard 402, a foot switch 403, and a barcode reader 404. The monitor 500 is, for example, a liquid crystal display or an organic EL display. The Web camera 600 transmits a shot image to the control device 700 through a network, such as the Internet. The Web camera 600 shoots, for example, the user who uses the microscope system 1.

According to the microscope system 1 having such a configuration as above, the projector 210 projects the assistive image on the image plane, so that the user can acquire necessary information without moving the eyes away from the ocular lenses 103. That is, necessary information can be acquired with such an AR display function.

Furthermore, the microscope system 1 achieves the AR display function described above as an augmented function to an existing microscope with the ocular tube 200 housing a set of constituents for projection of the assistive image on the image plane, instead of with an intermediate tube for augmentation in function. Thus, the height of location of the eye points in the microscope 100 is prevented from deviating largely from the height of location of the eye points in an existing microscope. That is, the ocular tube 200 and the microscope system 1 enable provision of the AR display function with the microscope having the eye points kept at a proper height.

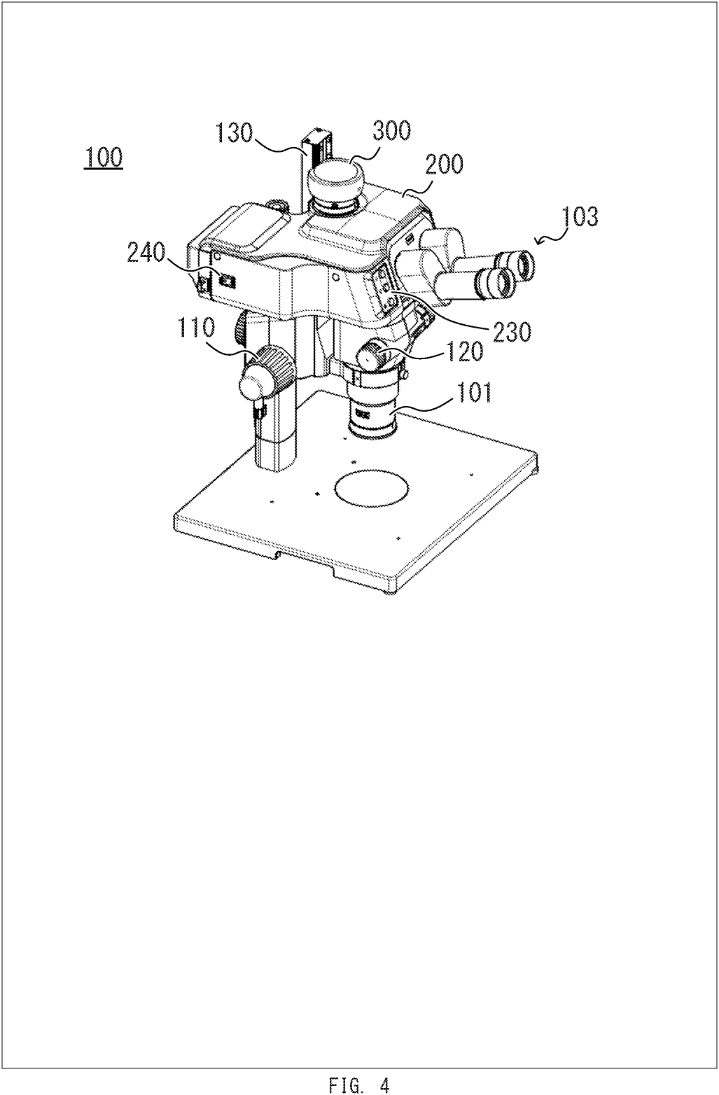

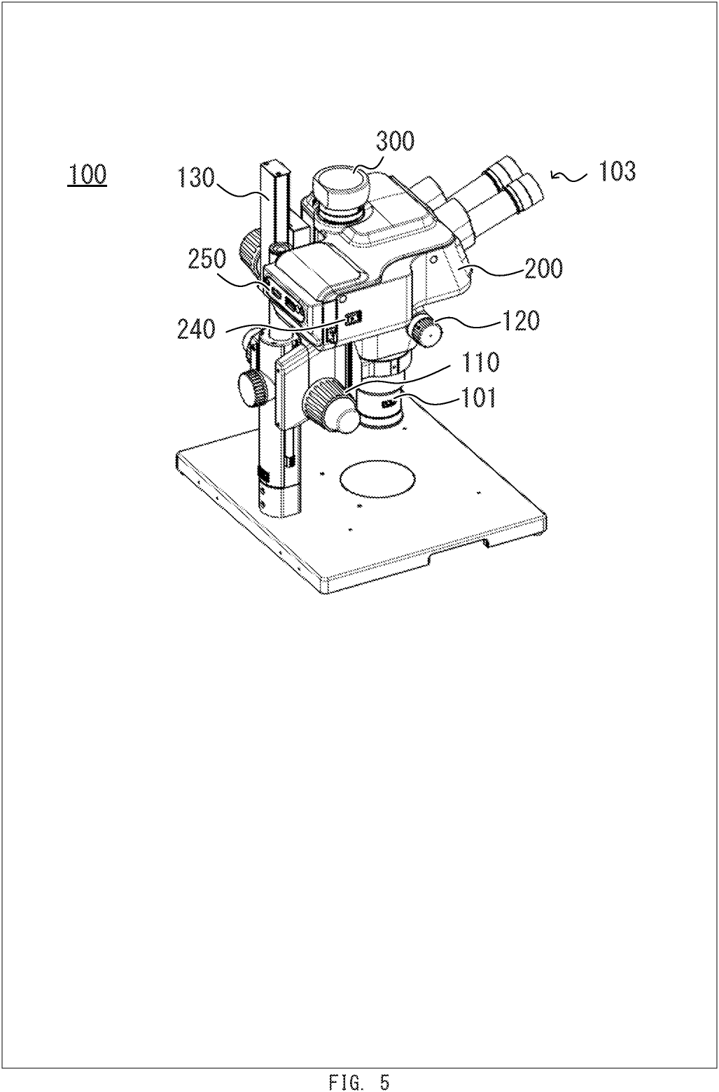

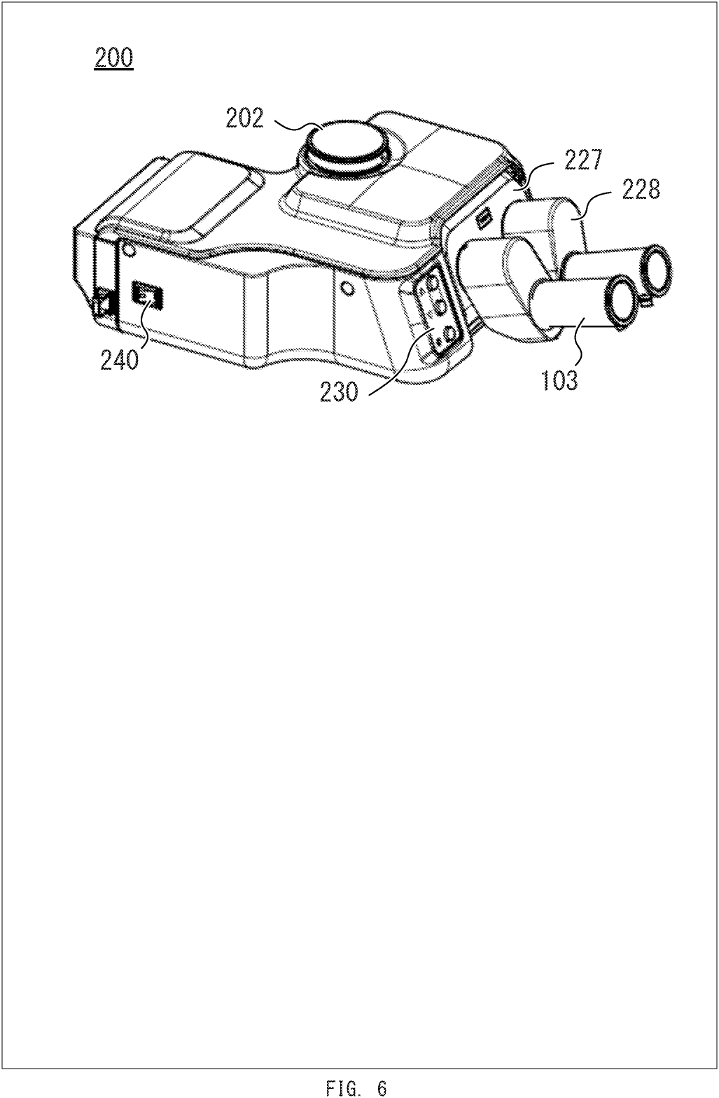

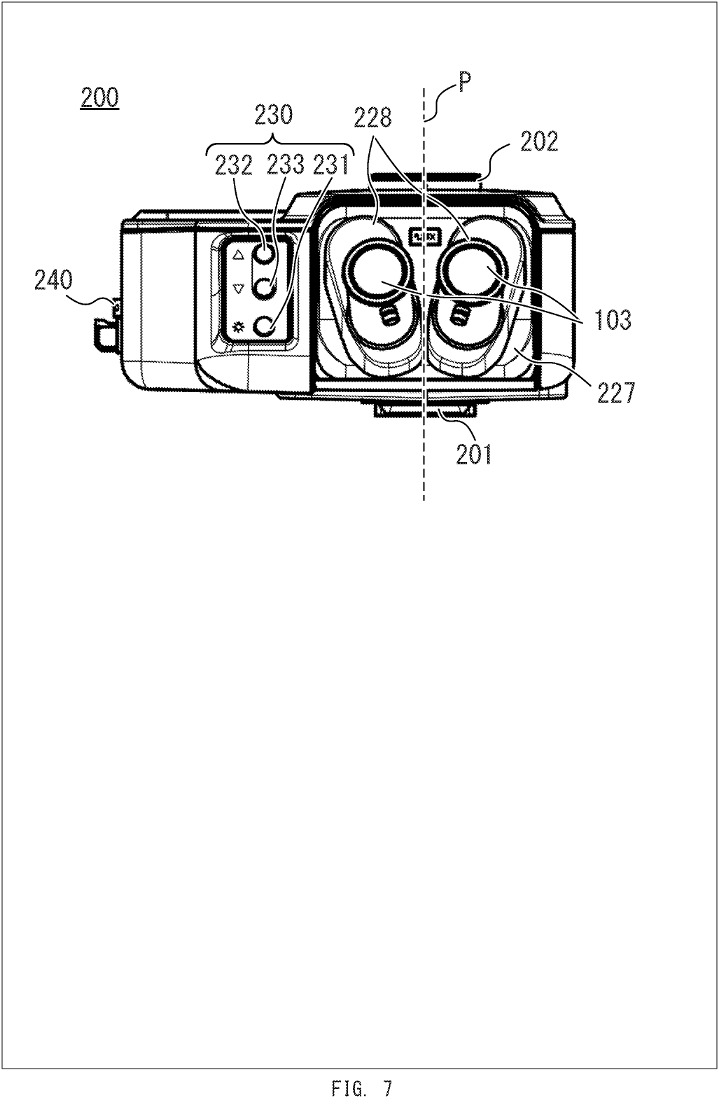

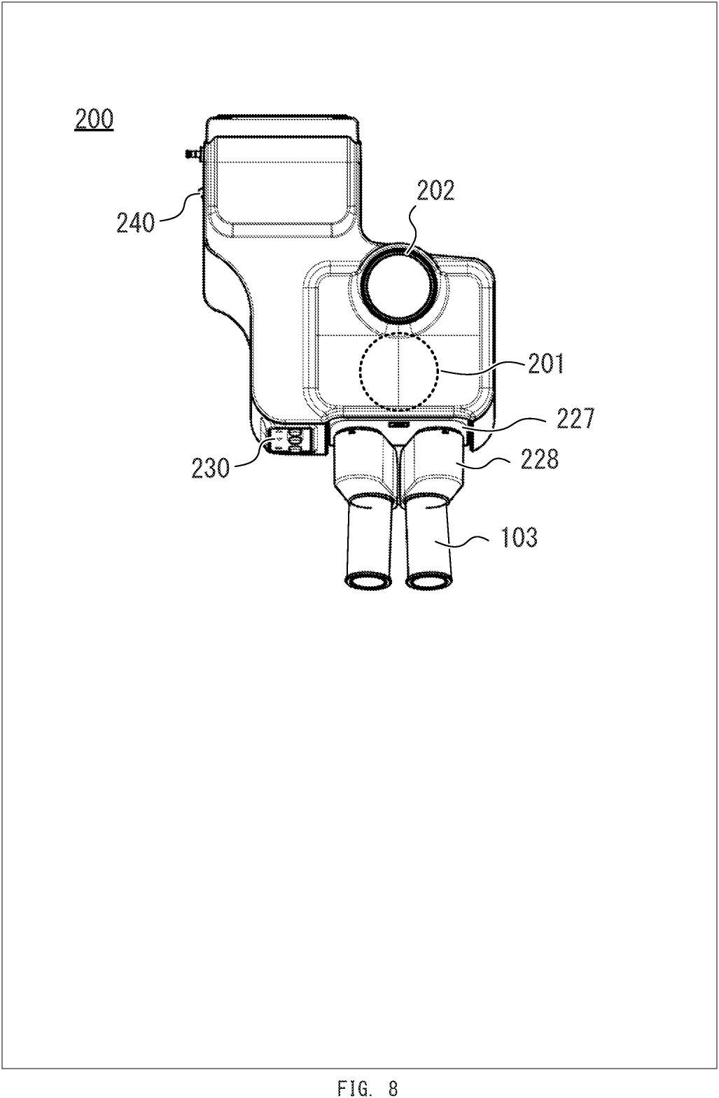

The ocular tube 200 that provides the AR display function will be described in more detail below. FIG. 4 is a perspective view of the microscope according to the embodiment of the present invention viewed from obliquely in front. FIG. 5 is a perspective view of the microscope according to the embodiment of the present invention viewed from obliquely behind. FIG. 6 is a perspective view of the ocular tube according to the embodiment of the present invention. FIG. 7 is a front view of the ocular tube according to the embodiment of the present invention. FIG. 8 is a top view of the ocular tube according to the embodiment of the present invention. The ocular tube 200 will be described based on the external appearance of the ocular tube 200 with reference to FIGS. 4 to 8.

As illustrated in FIGS. 4 and 6 to 8, the ocular tube 200 has a front face, to which the ocular lenses 103 are attached, provided with the operation unit 230 that receives an instruction to the projector 210. In addition, as illustrated in FIGS. 4 to 8, the ocular tube 200 has a side face provided with a main power switch 240 for the ocular tube 200 with the AR display function.

As illustrated in FIG. 7, the operation unit 230 is provided with a switch 231 that switches the AR display function between ON and OFF and switches 232 and 233 that adjust brightness for AR display. The switch 232 serves as a switch for an increase in brightness for AR display. A press of the switch 232 causes an increase in the quantity of light that the projector 210 emits. Meanwhile, the switch 233 serves as a switch for a decrease in brightness for AR display. A press of the switch 233 causes a decrease in the quantity of light that the projector 210 emits.

As illustrated in FIGS. 7 and 8, the operation unit 230 and the switch 240 are both located on the left side of the user who is looking through the ocular lenses 103. As above, the operation unit 230 and the switch 240 disposed collectively on the same side to the user enable the user to operate various types of switches one-handed.

As illustrated in FIG. 7, when the ocular tube 200 is viewed from in front, the circular joint 201 as the fastener to the microscope 100 and the circular joint 202 as the fastener to the image capturing device 300 are provided intersecting a plane P passing the center between the ocular lenses 103 as binoculars. That is, the central axis of the circular joint 201 and the central axis of the circular joint 202 are both located substantially in the plane P.

The median line of the user who is looking through the ocular lenses 103 is located substantially in the plane P. Thus, because of the circular joint 201, having the input opening through which beams of light from the objective 101 travel, with its central axis in the plane P, the sample to be observed is located at the front of the user who is looking through the ocular lenses 103. Such a configuration is important for facilitation of various types of work that the user carries out to the sample while looking through the ocular lenses 103, and contributes such that the microscope 100 including the ocular tube 200 provides high workability.

The ocular tube 200 houses the constituents for achieving AR display as an augmented function on one side with respect to the plane P, more specifically, on the left side when viewed from in front. That is, the projector 210 is provided at a position offset from the central line between the ocular lenses 103 attached in pairs (ocular lenses 103a and 103b). Thus, the ocular tube 200 is asymmetric with respect to the plane P and has a protrusion on its left side, as illustrated in FIGS. 4 to 8. More particularly, as illustrated in FIGS. 4 to 6 and 8, the left protrusion extends backward.

Such a shape enables an adequate space for housing the constituents for providing the AR display function in the ocular tube 200 without an excessively large degree of protrusion on one side (left side). In addition, a large back space can be ensured behind the attachable structures (fasteners). As illustrated in FIGS. 4 and 5, the ensured back space can be used for disposition of the support of a stand. Thus, the ocular tube 200 enables provision of the AR display function with high compatibility with other microscope products.

As illustrated in FIG. 5, the back face of the ocular tube 200, more specifically, the back face of the left protrusion extending backward is provided with a connector 250 for a cable for signal exchange with the projector 210. The projector 210 oriented to the front is housed at the innermost portion of the left protrusion extending backward, namely, near the connector 250.

Specifically, a power cable, a control cable, and a picture input cable are connected to the connector 250, so that power and signals are supplied to the projector 210 through the cables. Note that, among the three cables, the control cable and the picture input cable each have the other end connected to the control device 700.

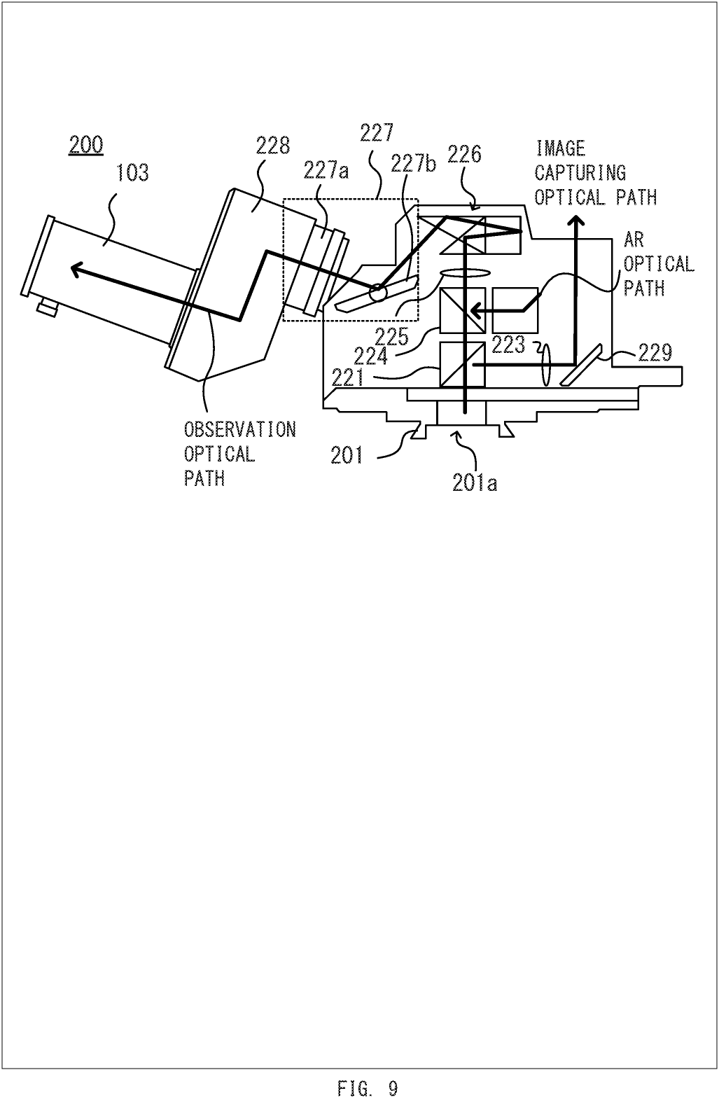

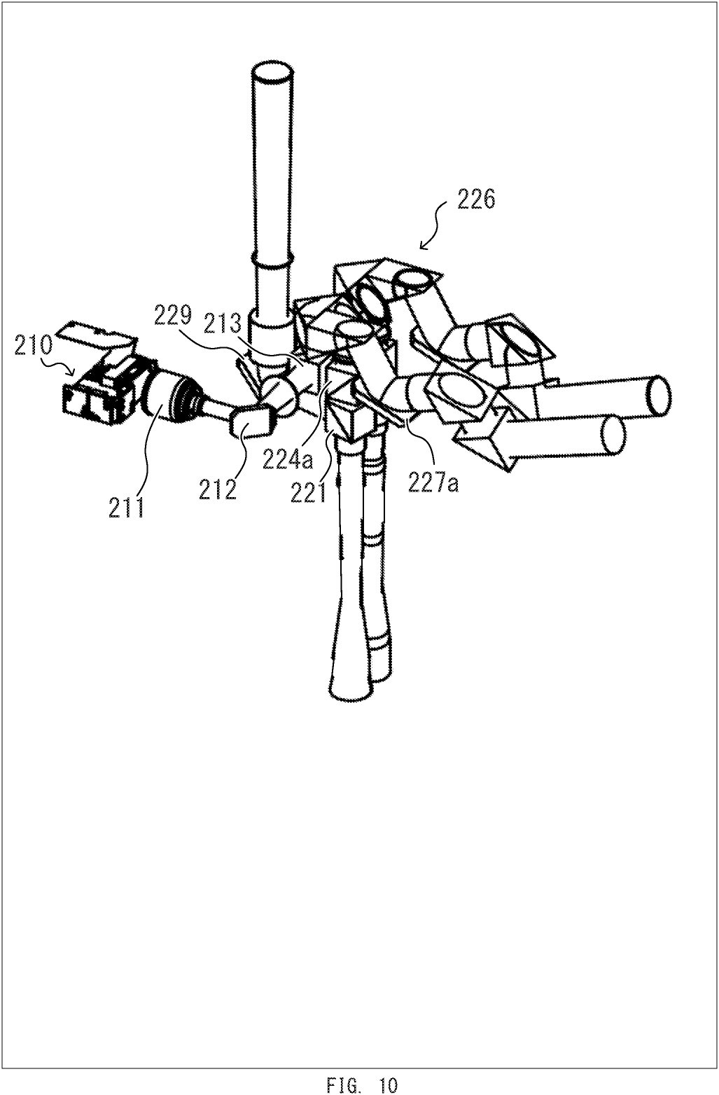

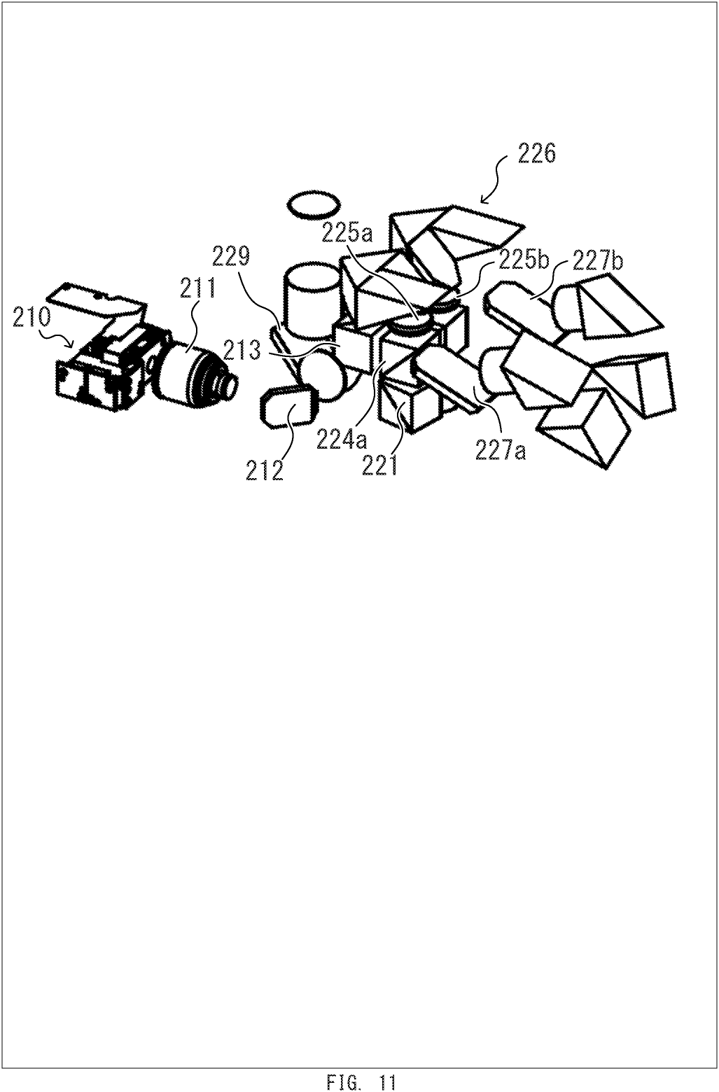

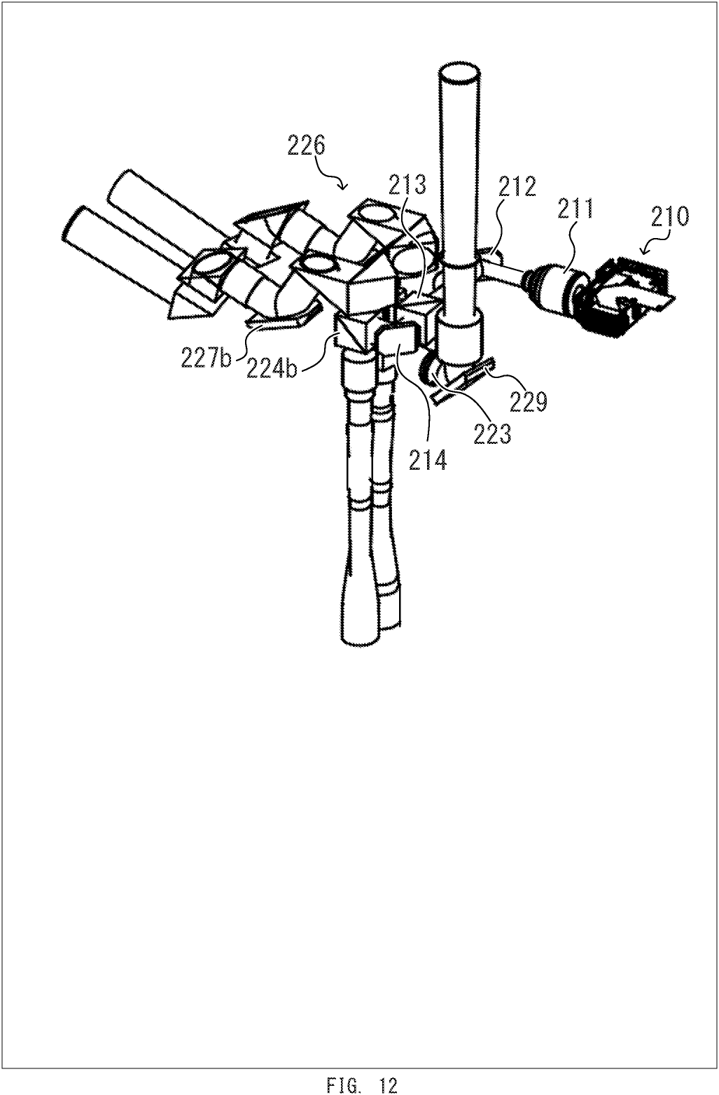

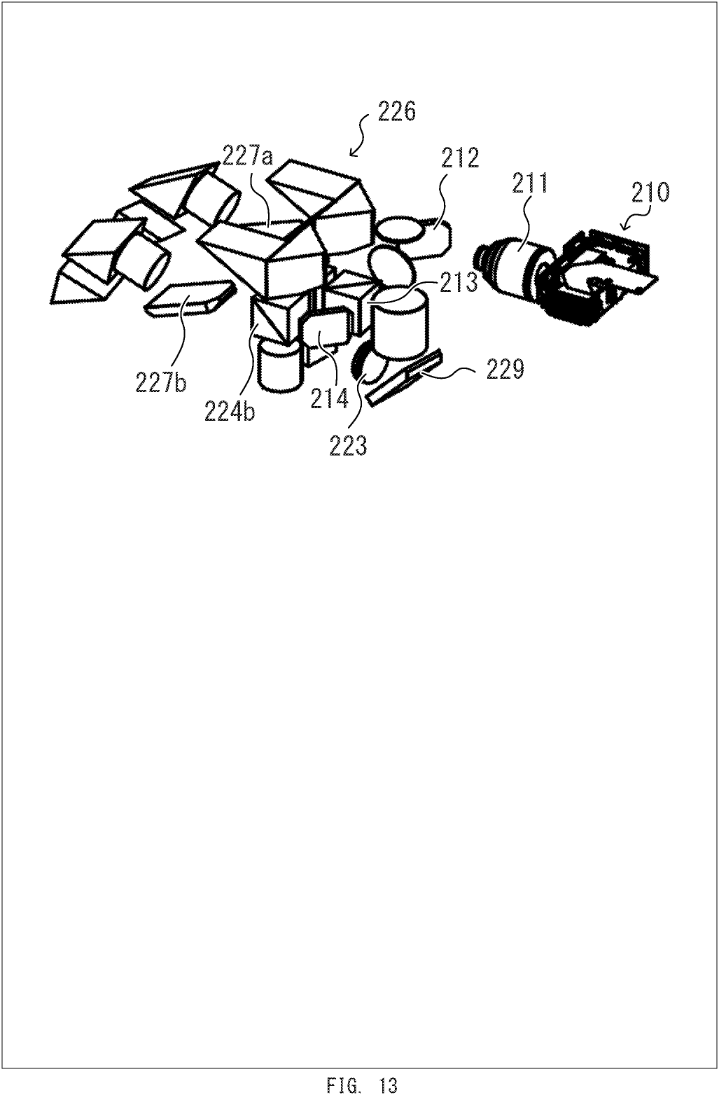

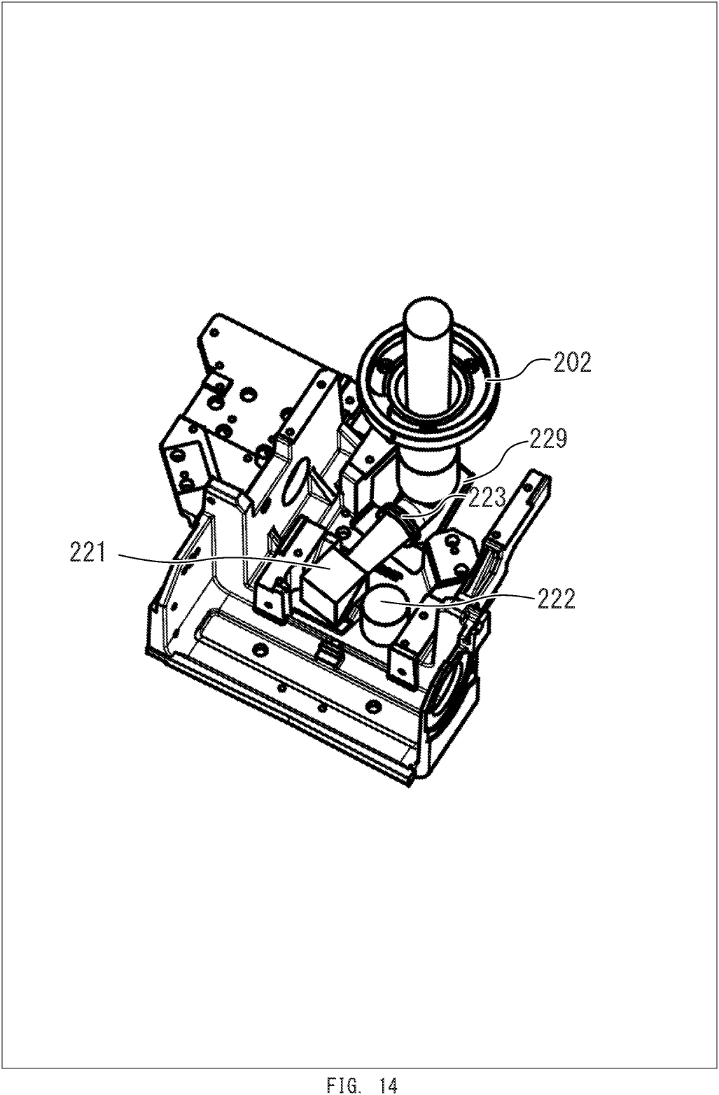

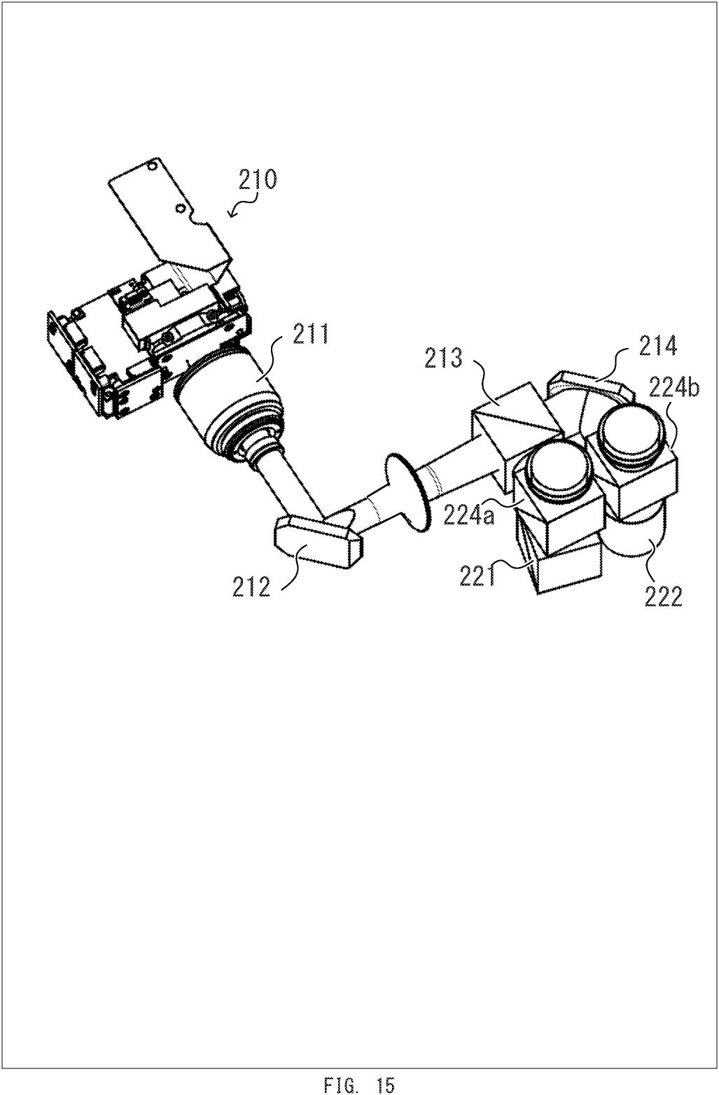

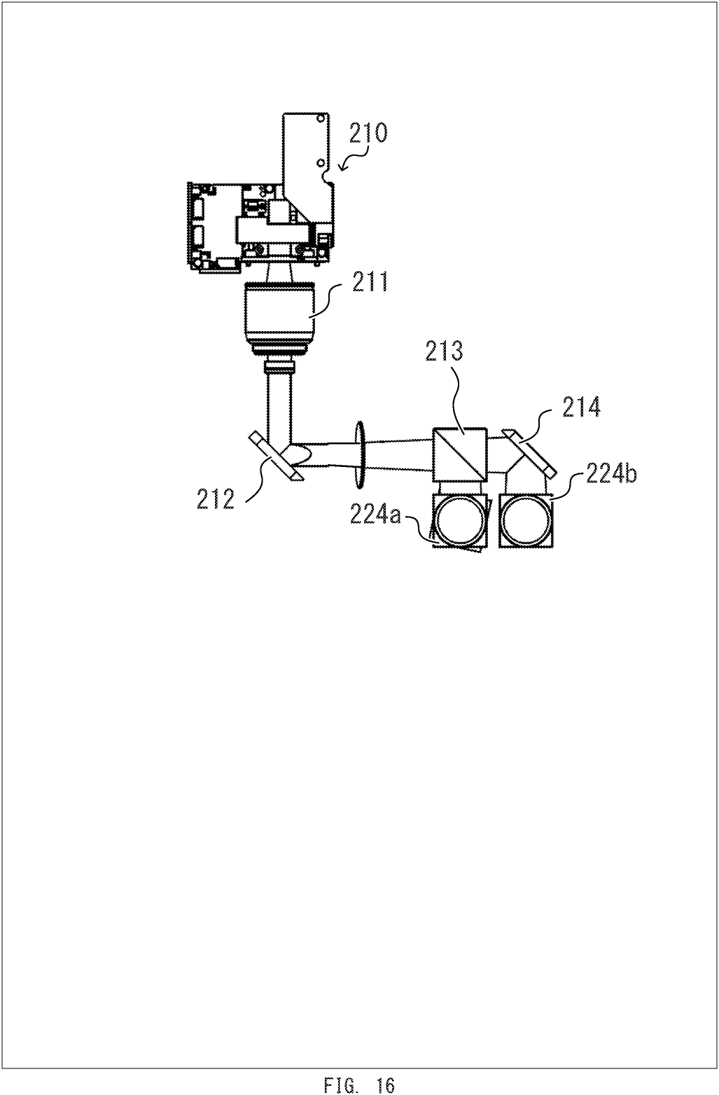

FIG. 9 illustrates the configuration of the ocular tube according to the embodiment of the present invention. FIG. 10 illustrates an optical path in the ocular tube according to the embodiment of the present invention viewed from obliquely in front. FIG. 11 illustrates an optical system in the ocular tube according to the embodiment of the present invention viewed from obliquely in front. FIG. 12 illustrates the optical path in the ocular tube according to the embodiment of the present invention viewed from obliquely behind. FIG. 13 illustrates the optical system in the ocular tube according to the embodiment of the present invention viewed from obliquely behind. FIG. 14 illustrates a configuration for guiding light branching off from the observation optical path of the stereoscopic microscope to the image capturing device. FIG. 15 illustrates a configuration for guiding light emitted from the projector 210 to the observation optical path of the stereoscopic microscope, viewed from obliquely above. FIG. 16 illustrates the configuration for guiding light emitted from the projector 210 to the observation optical path of the stereoscopic microscope, viewed from above. The ocular tube 200 will be described below based on the internal configuration of the ocular tube 200 with reference to FIGS. 9 to 16.

As illustrated in FIG. 9, light having passed through the objective 101 and one of the zoom lenses 102 enters, as a parallel pencil of light, the ocular tube 200 through an input opening 201a that the circular joint 201 has.

For example, as illustrated in FIGS. 9 to 11, as part of the light having entered from the microscope 100 to the ocular tube 200, light to travel in one of the right-eye optical path and the left-eye optical path (in this example, in the left-eye optical path) first enters the beam splitter 221. As illustrated in FIG. 9, the beam splitter 221 divides the light from the microscope 100 into light to the ocular lens 103 (namely, light to travel in the observation optical path) and light to the image capturing device 300 (namely, light to travel in the image capturing optical path).

According to a configuration in which the beam splitter 221, which causes the image capturing optical path to branch off from the observation optical path, is disposed closer to the input opening 201a than the beam splitter 224, which causes the AR optical path to join the observation optical path, is, the light from the projector 210 can be prevented from entering the image capturing device 300. Thus, only the light from the sample can be guided to the image capturing device 300, so that the image capturing device 300 can acquire a digital image of the sample, in which no AR image is shown. Because of the digital image including no AR image, for example, in analysis of the digital image with artificial intelligence, the state of the sample can be determined properly with no AR image as an interruption in image analysis.

Even with a configuration in which the beam splitter 224 is disposed closer to the input opening 201a than the beam splitter 221 is, if exposure timing and projection timing are controlled not to be identical, the image capturing device 300 can acquire a digital image of the sample, in which no AR image is shown. Note that, in this case, particularly, in a case where the projector 210 is of a field sequential type, it is difficult to adjust the brightness of the optical image and the brightness of the assistive image, individually. Therefore, desirably, the beam splitter 221 is disposed closer to the input opening 201a than the beam splitter 224 is. Note that combination of the digital image and the AR image can be performed freely on the control device 700.

The beam splitter 221 serves as a beam splitter that forms transmitted light larger in quantity than reflected light from incident light. Thus, the beam splitter 221 guides a larger quantity of light to the observation optical path as a transmittance optical path than to the image capturing optical path as a reflection optical path. Specifically, the beam splitter 221 has, but is not particularly limited to, for example, a high-transmittance optical characteristic of which the transmittance is 80% and the reflectance is 20%. This enables bright observation of the sample with acquisition of a digital image by the image capturing device 300.

Meanwhile, as illustrated in FIGS. 14 and 15, as part of the light having entered from the microscope 100 to the ocular tube 200, light to travel in the other of the right-eye optical path and the left-eye optical path (in this example, in the right-eye optical path) first enters the ND prism 222.

The ND prism 222 serves as an optical element that suppresses the quantity of light. The ND prism 222 is provided in order to suppress difference in the quantity of light between the left and right optical paths, and thus is required to allow incident light to pass through, in accordance with the transmittance of light of the beam splitter 221. In a case where the beam splitter 221 has an optical characteristic of which the transmittance is 80%, desirably, the ND prism 222 has an optical performance in which light is reduced by 20%.

The ND prism 222 is also used to suppress difference in optical path length between the left and right optical paths. The beam splitter 221 and the ND prism 222 identical in prism length enable equivalence in optical path length between the right-eye optical path and the left-eye optical path, leading to suppression of difference in optical performance, such as peripheral illumination.

As illustrated in FIGS. 9 and 14, the light guided to the image capturing optical path after reflecting off the beam splitter 221 enters the image-forming lens 223. The image-forming lens 223 is disposed between the beam splitter 221 and the image capturing device 300.

An image-forming lens to be disposed in an ocular tube is often provided near an input opening. In contrast to this, the ocular tube 200 has the beam splitter 221 provided between the image-forming lens 223 and the circular joint 201. Thus, the image-forming lens 223 is provided in the casing of the ocular tube 200. Because the image-forming lens 223 is not exposed outward from the casing, the image-forming lens 223 does not dirty easily, so that deterioration is less likely to occur in optical performance.

The light having entered the image-forming lens 223 is converted into a convergent pencil of light. As illustrated in FIGS. 9, 12, and 14, the convergent pencil of light is reflected vertically upward by a reflective member 229. After that, the reflected light is condensed on the image capturing face of the image capturing device 300 through the output opening that the circular joint 202 has.

Note that the beam splitter 221 that guides light to the image capturing optical path is disposed to reflect incident light toward the back face of the ocular tube 200. That is, the image capturing optical path extends from the observation optical path toward the back face of the ocular tube 200 and then extends vertically upward to the image capturing device 300 attached to the upper portion of the ocular tube 200 by changing in direction below the circular joint 202. Thus, as illustrated in FIG. 8, with the circular joint 201 and the circular joint 202 both disposed intersecting the plane P passing through the center between the ocular lenses 103, the number of times of folding of a beam of light to the image capturing device 300 is minimized.

The configuration in which the circular joint 201 and the circular joint 202 are disposed intersecting the plane P is desirable for minimization of adverse influence due to a bias in the center of gravity of the ocular tube 200 to which the image capturing device 300 is attached. For example, because the plane P that the circular joint 201 and the circular joint 202 intersect is parallel to the vertical direction, a reduction can be made in the influence of the image capturing device 300 as a relatively heavy structure fixed to the upper face of the ocular tube 200. As a result, for example, the circular joint 201 can be protected against excessive bending stress.

As illustrated in FIGS. 9 to 13 and 15, the light having passed through the beam splitter 221 on the left optical path and the light having passed through the ND prism 222 on the right optical path then enter, respectively, the beam splitter 224a and the beam splitter 224b. Meanwhile, as illustrated in FIGS. 9 to 13, 15, and 16, the light from the AR optical path enters the beam splitter 224a and the beam splitter 224b.

More particularly, the light from the projector 210 is first converted into a parallel pencil of light by the projection lens 211. The projection lens 211 is set at a magnification such that the number of projection elements of the projector 210 included in the field of view (e.g., the number of mirrors of a digital mirror device), namely, the number of pixels is maximum and additionally an image from the projector 210 fulfills the field of view of each ocular lens 103, namely, the image from the projector 210 is projected equally to or larger than the field number in size. The projection lens 211 has a numerical aperture (NA) such that a resolving power finer than the pixel size is acquired. Thus, a high-definition assistive image can be projected over the entire field of view.

The parallel pencil of light resulting from the conversion by the projection lens 211 enters the beam splitter 213 after reflecting off the adjustment mechanism 212. The beam splitter 213 divides the incident light into light to the beam splitter 224a placed on the left-eye optical path and light to the beam splitter 224b placed on the right-eye optical path. Specifically, the beam splitter 213 is an exemplary third optical element and has an optical characteristic of which the transmittance is 50% and the reflectance is 50%. Thus, the beam splitter 213 can guide light equal in quantity to each of the right-eye optical path and the left-eye optical path.

The light to the beam splitter 224a resulting from the division by the beam splitter 213 enters directly the beam splitter 224a. Meanwhile, the light to the beam splitter 224b enters the beam splitter 224b after reflecting off the adjustment mechanism 214.

The two adjustment mechanisms each have a reflective member and a mechanism capable of adjusting biaxially the normal direction of the reflective face of the reflective member to the reflective face of the reflective member. The reflective member included in the adjustment mechanism 212 is disposed on the optical path between the projector 210 and the beam splitter 213. A change in the orientation of the reflective member causes a change in the travel direction of reflected light from the adjustment mechanism 212. Thus, the position of the left-eye assistive image and the position of the right-eye assistive image can be adjusted on the image plane. Note that the adjustment mechanism 212 is used mainly in order to adjust the position of the left-eye assistive image formed on the left-eye optical path. That is, the adjustment mechanism 212 serves as an adjuster that adjusts the position of the left-eye assistive image formed on the left-eye optical path.

Meanwhile, the reflective member included in the adjustment mechanism 214 is disposed on the optical path between the beam splitter 213 and the beam splitter 224b. A change in the orientation of the reflective member causes a change in the travel direction of reflected light from the adjustment mechanism 214. Thus, the position of the right-eye assistive image can be adjusted on the image plane. The adjustment mechanism 214 is used in order to adjust the position of the right-eye assistive image formed on the right-eye optical path. That is, the adjustment mechanism 214 serves as an adjuster that adjusts the position of the right-eye assistive image formed on the right-eye optical path.

In the ocular tube 200, the adjustment mechanism 212 and the adjustment mechanism 214 each adjust the position of the assistive image on the image plane, enabling independent adjustment of the positions of the left and right assistive images to the left and right optical images. Thus, the relative positional relationship between the optical image and the assistive image can be individually adjusted, so that an improvement can be made in simultaneous fusion between the optical image and the assistive image.

Light from the microscope 100 and light from the projector 210 enter the beam splitters 224. As illustrated in FIG. 9, the beam splitter 224 causes the light from the projector 210 to join the optical path for the light from the microscope 100. More particularly, as illustrated in FIGS. 15 and 16, as the beam splitters 224, provided are the beam splitter 224a serving as a first left-eye optical element that is disposed on the left-eye optical path and causes the light from the projector 210 to join the left-eye optical path and the beam splitter 224b serving as a first right-eye optical element that is disposed on the right-eye optical path and causes the light from the projector 210 to join the right-eye optical path.

The beam splitters 224 (beam splitters 224a and 224b) each serve as a beam splitter that forms transmitted light larger in quantity than reflected light from incident light. With a small loss on the light from the microscope 100, the beam splitters 224 each combine the light from the projector 210 with the light from the microscope 100. Specifically, the beam splitters 224 each have, but not particularly limited to, for example, a high-transmittance optical characteristic of which the transmittance is 80% and the reflectance is 20%. Thus, the light from the microscope 100 without being largely reduced in quantity can be combined with the light from the projector 210.

Light resulting from the combination by each beam splitter 224 then enters the corresponding image-forming lens 225. The light resulting from the combination by each beam splitter 224 corresponds to a parallel pencil of light. Thus, the light (including the light from the microscope 100 and the light from the projector 210) resulting from the combination by each beam splitter 224 is converted into a convergent pencil of light by the corresponding image-forming lens 225, leading to image formation on a plane. Thus, the assistive image is formed on the image plane on which the optical image is formed. More particularly, as illustrated in FIG. 11, the light traveling on the left-eye optical path is converted into a convergent pencil of light by the image-forming lens 225a, and the light traveling on the right-eye optical path is converted into a convergent pencil of light by the image-forming lens 225b.

As illustrated in FIG. 9, the convergent pencil of light resulting from the conversion by each image-forming lens 225 then enters the corresponding folded optical system 226. The folded optical systems 226 each serve as an optical system that folds the travel direction of incident light. Herein, the folded optical systems 226 each fold, downward, the light from the projector 210 and the light from the microscope 100 that travel upward in the vertical direction.

As the folded optical systems 226, as illustrated in FIGS. 2 and 10 to 13, provided are the folded optical system 226a disposed on the left-eye optical path and the folded optical system 226b disposed on the right-eye optical path. For each of the folded optical systems 226 (folded optical systems 226a and 226b), for example, a Porro prism can be adopted. The folded optical systems 226 each direct downward the travel direction of light to prevent the corresponding eye point from being located at an excessively high height. Thus, the height of location of the eye points can be suppressed.

The ocular tube 200 has the image-forming lenses 225 each disposed between the corresponding beam splitter 224 and folded optical system 226. Thus, the image-forming lenses 225 are provided in the casing of the ocular tube 200. Because the image-forming lenses 225 are not exposed outward from the casing, the image-forming lenses 225 do not dirty easily, so that deterioration is less likely to occur in optical performance.

In comparison to a configuration that has an image-forming lens disposed near an input opening and is often adopted for an ocular tube, the ocular tube 200 has each image-forming lens 225 disposed at a higher position in the ocular tube 200. As above, each image-forming lens 225 is disposed at a higher position, namely, near the corresponding folded optical system 226, so that the optical path directed downward from the folded optical system 226 can be lengthened than ever before. Thus, the height of location of the eye points can be designed lower.

The light emitted downward from each folded optical system 226 then enters, as illustrated in FIG. 9, the corresponding ocular lens 103 through the eye-point height adjustment mechanism 227 and the eyepiece-distance adjustment mechanism 228.

The eye-point height adjustment mechanism 227 serve as a height adjuster that adjusts the height of location of the eye points, provided closer to the ocular lenses 103 than the folded optical systems 226 are. As illustrated in FIG. 9, the eye-point height adjustment mechanism 227 includes a turner 227a that turns in a rise-fall direction around its horizontal shaft together with the ocular lenses 103 and a reflective member 227b that is attached to the shaft of the turner 227a and turns around the shaft by half the amount of turning of the turner 227a.

Turning of the reflective member 227b by half the amount of turning of the turner 227a increases (or decreases) each of the angle of incidence of light incident from each folded optical system 226 to the reflective member 227b and the angle of emergence of light reflected from the reflective member 227b, by half the amount of turning. That is, the light incident from each folded optical system 226 to the reflective member 227b deflects by the angle equivalent to the amount of turning through the reflective member 227b.

Therefore, regardless of the orientation of the turner 227a, the angle of incidence of light to each ocular lens 103 is kept constant at all times, so that the position of image formation to each ocular lens 103 is kept. Thus, without deterioration in observation performance, the height of location of the eye points can be freely adjusted with the eye-point height adjustment mechanism 227, for example, in accordance with the user’s height.

The eyepiece-distance adjustment mechanism 228 is, for example, of a Seidentopf type. Note that a structure of a different type may be adopted. Use of the eyepiece-distance adjustment mechanism 228 enables adjustment of the distance between the ocular lenses 103 based on the distance between the pupils of the user.

Provision of the eye-point height adjustment mechanism 227 and the eyepiece-distance adjustment mechanism 228 enables adjustment of the height of location of the eye points and adjustment of the distance between the left and right eye points, based on user’s physical features (e.g., the height or sitting height and the distance between the pupils). Thus, with achievement of a high ergonomic performance, a reduction can be made in the workload of the user to the microscope system 1.

Since the eye-point height adjustment mechanism 227 and the eyepiece-distance adjustment mechanism 228 are provided downstream of the position at which the AR optical path and the observation optical path join together, slight image displacement due to mechanical motions of the adjustment mechanisms occurs in the optical image and the assistive image by the same quantity. Thus, with retention of simultaneous fusion between the optical image and the assistive image, various types of adjustment can be carried out.

The light having passed through the eye-point height adjustment mechanism 227 and the eyepiece-distance adjustment mechanism 228 enters the ocular lenses 103. For example, the ocular lenses 103 may be each a concave lens, and the microscope 100 may be a Galilean stereoscopic microscope. A concave lens may be used for each ocular lens 103 in order to make the ocular tube 200 compact. Through the ocular lenses 103, the user can check an image in which the assistive image is superimposed on the optical image.

In the ocular tube 200 having such a configuration as above, as described above, the image-forming lenses 225 are each disposed close to the corresponding folded optical system 226, so that the height of location of the eye points can be suppressed low. Thus, the ocular tube 200 housing the constituents necessary for AR display enables inhibition of a rise in the height of location of the eye points, in comparison to a case where an intermediate tube is used, namely, the ocular tube 200 as a single item enables the height of location of the eye points to be suppressed lower. Thus, the entire microscope system 1 enables inhibition of a rise in the height of location of the eye points due to augmentation in function.

The ocular tube 200 includes the image-forming lenses 225 for observation and the image-forming lens 223 for image capturing, separately. Thus, such two types of image-forming lenses can be made different in focal length. Specifically, the image-forming lenses 225 are shorter in focal length than the image-forming lens 223. Since the image-forming lenses 225 are shorter in focal length than the image-forming lens 223, the image capturing device 300 can acquire an image of which the range is wider than the range of the sample that the user is observing through the ocular lenses 103. Furthermore, because the image-forming lenses 225 each have a short local length, the ocular tube 200 can be designed thinner in the height direction than ever before, so that the ocular tube 200 can be made compact. Furthermore, because of a lower height of installation of the image capturing device 300, the ocular tube 200 to which the image capturing device 300 is attached can have a lower center of gravity.

The ocular tube 200 having the AR display function has the observation optical path, the AR optical path, and the image capturing optical path in a single casing. The positional relationship therebetween is constant at all times in the casing. Thus, a considerable reduction can be made in the adjustment work that the user should carry out for observation with the AR display function, in comparison to a case where such an AR display function is achieved with an intermediate tube.

The embodiments described above are specific examples for facilitating understanding of the invention, and thus the present invention is not limited to the embodiments. Modifications of the embodiments described above and alternatives to the embodiments described above are to be included. That is, the constituent elements in each embodiment can be modified without departing from the spirit and scope of the invention. Appropriate combination of a plurality of constituent elements disclosed in one or more of the embodiments enables a new embodiment. Some constituent elements may be omitted from the constituent elements in each embodiment, or some constituent elements may be added to the constituent elements in each embodiment. Furthermore, the procedure of processing in each embodiment may be changed in order as long as there is no contradiction. That is, the ocular tube according to the present invention can be variously modified or altered without departing from the scope of the claims.

What is claimed is:

1. An ocular tube for a microscope, the ocular tube to which an ocular lens is to be attached, the ocular tube comprising:
a superimposition device configured to superimpose an assistive image on an image plane on which an optical image is formed with light from the microscope.

2. The ocular tube according to claim 1, further comprising:
a first optical element configured to cause light from the superimposition device to join an optical path for the light from the microscope;
a folded optical system configured to fold a travel direction of the light from the superimposition device and the light from the microscope; and
an image-forming lens disposed between the first optical element and the folded optical system, wherein
the superimposition device serves as a projector to project the assistive image on the image plane.

3. The ocular tube according to claim 2, further comprising
a second optical element configured to divide the light from the microscope into light to the ocular lens and light to a digital camera, wherein
the ocular tube serves as a trinocular tube to which the digital camera is to be attached.

4. The ocular tube according to claim 3, further comprising:
a fastener having an input opening for the light from the microscope, the fastener being configured to fasten the ocular tube to the microscope; and
a second image-forming lens disposed between the digital camera and the second optical element, wherein
the second optical element is disposed between the image-forming lens and the fastener.

5. The ocular tube according to claim 4, wherein
the image-forming lens is different in focal length from the second image-forming lens.

6. The ocular tube according to claim 4, wherein
the second image-forming lens is shorter in focal length than the image-forming lens.

7. The ocular tube according to claim 4, wherein
the second image-forming lens is provided in a casing of the ocular tube such that the second image-forming lens is not exposed outward from the casing.

8. The ocular tube according to claim 3, further comprising
an optical element configured to suppress a quantity of light, wherein
a right-eye optical path and a left-eye optical path are provided for a stereoscopic microscope,
the second optical element is disposed on one of the right-eye optical path and the left-eye optical path, and
the optical element is disposed on another of the right-eye optical path and the left-eye optical path.

9. The ocular tube according to claim 3, wherein
the second optical element serves as a beam splitter that forms transmitted light larger in quantity than reflected light from incident light.

10. The ocular tube according to claim 2, wherein
a right-eye optical path and a left-eye optical path are provided for a stereoscopic microscope, and
the first optical element includes:
a first right-eye optical element disposed on the right-eye optical path, the first right-eye optical element being configured to cause the light from the superimposition device to join the right-eye optical path; and
a first left-eye optical element disposed on the left-eye optical path, the first left-eye optical element being configured to cause the light from the superimposition device to join the left-eye optical path.

11. The ocular tube according to claim 10, further comprising:
a third optical element configured to divide the light from the superimposition device into light to the first right-eye optical element and light to the first left-eye optical element;
a first adjuster configured to adjust a position of a right-eye assistive image formed on the right-eye optical path; and
a second adjuster configured to adjust a position of a left-eye assistive image formed on the left-eye optical path, wherein
one of the first adjuster and the second adjuster includes a first reflective member adjustable in orientation disposed on an optical path between the superimposition device and the third optical element, and
another of the first adjuster and the second adjuster includes a second reflective member adjustable in orientation disposed on an optical path between the third optical element and the first right-eye optical element or the first left-eye optical element.

12. The ocular tube according to claim 2, further comprising
a height adjuster provided closer to the ocular lens than the folded optical system is, the height adjuster being configured to adjust a height of location of an eye point.

13. The ocular tube according to claim 12, wherein
the height adjuster includes:
a turner to which the ocular lens is to be attached, the turner being configured to turn in a rise-fall direction around a horizontal shaft; and
a reflective member attached to the horizontal shaft of the turner, the reflective member being configured to turn around the horizontal shaft by half an amount of turning of the turner.

14. The ocular tube according to claim 2, wherein
the first optical element serves as a beam splitter that forms transmitted light larger in quantity than reflected light from incident light.

15. The ocular tube according to claim 2, wherein
the image-forming lens is provided in a casing of the ocular tube such that the image-forming lens is not exposed outward from the casing.

16. The ocular tube according to claim 1, further comprising
the ocular lens, wherein
the ocular lens serves as a concave lens.

17. The ocular tube according to claim 1, wherein
the ocular tube has a single casing.

18. The ocular tube according to claim 1, wherein
the superimposition device is provided at a position offset from a central line between two ocular lenses attached to the ocular tube.

19. The ocular tube according to claim 1, further comprising
a connector for a cable for signal exchange with the superimposition device, on a back face of the ocular tube.

20. The ocular tube according to claim 1, further comprising
an operation unit provided on a front face of the ocular tube, the front face to which the ocular lens is to be attached, the operation unit being configured to receive an instruction to the superimposition device.
